(19) United States
(12) Patent Application Publication
(10) Pub. No.: US 2013/0096934 A1
(43) Pub. Date: Apr. 18, 2013

(54) PERCOLATOR SYSTEMS AND METHODS

(71) Applicants: Jerome V. VACCARO, Mount Kisco, NY (US); Amir J. Segev, Ellicott City, MD (US)

(72) Inventors: Jerome V. VACCARO, Mount Kisco, NY (US); Amir J. Segev, Ellicott City, MD (US)

(73) Assignee: APS Healthcare Bethesda, Inc., White Plains, NY (US)

(21) Appl. No.: 13/442,410

(22) Filed: Apr. 9, 2012

Related U.S. Application Data
(60) Provisional application No. 61/472,774, filed on Apr. 7, 2011.

(51) Int. Cl. G06F 19/00

(52) U.S. Cl. CPC G06F 19/3431
USPC 705/2

(57) ABSTRACT

The present percolator systems and methods identify and coordinate outreach for members who are potentially at risk, based in part on contract requirements, automatically-assigned risk levels, or gaps in the members' healthcare, including gaps related to social considerations and workflow. Exemplary embodiments of the systems and methods may utilize business rules combined into triggers, with each trigger being assigned a weight. Each member may be assigned an outreach score by combining the weights of triggers applicable to that member. Members may then be assigned to a risk level, or acuity level, and prioritized for outreach according to their outreach scores. The risk level assignments may drive the type of staff and the type (i.e., personal, telephonic, mail, etc.) and frequency of outreach interactions. Other embodiments of the percolator systems and methods are also disclosed herein.

### CROSS-REFERENCE TO RELATED APPLICATIONS

The application claims priority and the benefit under 35 U.S.C. §119(e) of U.S. Provisional Patent Application No. 61/472,774, filed 7 Apr. 2011, which is incorporated herein by reference in its entirety as if fully set forth below.

### TECHNICAL FIELD

Various embodiments of the present invention relate to percolator systems and methods and, more particularly, to percolator systems and methods for identifying and prioritizing at-risk members for outreach efforts.

### BACKGROUND

For various reasons, medical insurers often spend more than necessary for healthcare of their insureds, and insureds receive sub-optimal care and incur avoidable complications to their conditions. This is largely because many insureds fail to take advantage of timely and coordinated healthcare services. Due to lack of comprehensive technological infrastructure and the nature of health status in patients with multiple chronic conditions, the aspects of care coordination and continuity of care are compromised, which causes sub-optimal treatment, unnecessary utilization of acute services such as emergency room and hospitalizations, and insufficient disease control to prevent or delay complications and progression of disease.

Accordingly, there is a need to identify and contact insured patients who are at risk for complications and high expenditures because of ineffective use or underutilization of available healthcare services.

### SUMMARY

There is a need for percolator systems and methods to identify individuals who have complex health conditions and are receiving and utilizing healthcare resources sub-optimally. In addition, once these individuals are identified, there is a need to manage their multiple and complex issues by the most appropriate staff and in a prioritized manner, as many of the issues are interdependent and need to be addressed in a sequential manner. It is to such systems and methods, for identifying and prioritizing high-risk patients and their health problems, that various embodiments of the present invention are directed.

An exemplary embodiment of the percolator system may be applicable to a specific client, e.g., an insurance carrier, and analyzes various members, e.g., insureds, associated with the client. The percolator system may serve three major functions: (1) stratifying and assigning risk scores to members for the client; (2) ranking the priority of members and their issues that need to be addressed for each individual member associated with the client; and (3) driving workflow by assigning identified members to the most appropriate staff member and prioritizing activities for the staff. In some embodiments, the percolator may comprise a risk-evaluation unit, a ranking unit, and an assignment unit.

The risk-evaluation unit may rank a plurality of members according to one or more factors. These factors may include, without limitation, predictive modeling of health risk, actual member cost per month, utilization patterns, count of identified gaps in care, and complexity. Using a predetermined algorithm based on the chosen factors, the risk-evaluation unit may determine a risk score (also known as acuity) for each member. In some embodiments, the members may be categorized into risk groups based on their risk scores, and the groups may be based on score percentiles. The percolator system may calculate and reassign risk scores on a regular basis, such as periodically according to a schedule.

The ranking unit may assign an outreach score to each member based on one or more triggers. In an exemplary embodiment, the triggers may be customized for each client based on the client's outreach priorities. A trigger may comprise some combination of business rule sets, and each business rule set may be a combination of business rules. A business rule may represent a single question having a yes or no answer. For example, a business rule may represent the following question: “Has a plan of care been approved?” A business rule may also count a number of occurrences, such as number of chronic conditions a member has. Each client may identify a finite set of business rules relevant to its needs. The outreach score for each member may be calculated as a combination of weights, where each weight is associated with a predetermined trigger. The weights may be static, staying fixed over time, or they may be on a sliding scale where the weight increases as a predetermined timeframe gets closer or as some other predetermined criteria are approached or met.

A workflow assignment generated by the percolator system may be based on results of the risk-evaluation unit, the ranking unit, or both. The workflow assignment may identify both the most appropriate staff member who the member should be assigned to based on the member's identified issues, as well as the sequencing in which tasks or activities with the member should be executed.

These and other objects, features, and advantages of the invention will become more apparent upon reading the following specification in conjunction with the accompanying drawing figures.

### BRIEF DESCRIPTION OF THE FIGURES

FIG. 1 illustrates a diagram of a percolator system, according to an exemplary embodiment.

FIG. 2 illustrates a flow diagram of a percolator method, according to an exemplary embodiment.

FIG. 3 illustrates a flow diagram of a risk-assessment process of the percolator system, according to an exemplary embodiment.

FIG. 4 illustrates a computer system for implementing a percolator system, according to an exemplary embodiment.

### DETAILED DESCRIPTION

To facilitate an understanding of the principles and features of the invention, various illustrative embodiments are explained below. In particular, the invention is described in the context of being percolator systems and methods for prioritizing insureds for outreach, so as to reduce future insurance costs and complications, and so as to improve insurance utilization, clinical outcomes, and prevention of disease. Embodiments of the invention, however, need not be limited to this context. Rather, embodiments of the percolator systems and methods need not perform all of these tasks, and also may be used for prioritizing various entities for various purposes. For example, and not limitation, some embodiments of the invention may be used to prioritize potential customers for preventive health services, to identify health promotional material, or even for non-health-related purposes. Other uses for the various embodiments may also exist.

The materials and components described hereinafter as making up various elements of the invention are intended to be illustrative and not restrictive. Many suitable materials and components that would perform the same or similar functions as materials and components described herein are intended to be embraced within the scope of the percolator systems and methods. Such other components not described herein may include, but are not limited to, for example, components developed after development of the invention.

Various embodiments of the present invention are percolator systems and methods for prioritizing outreach and, in some embodiments, sequencing outreach tasks. An exemplary percolator system may be customized to a particular client and may produce at least one, and preferably two or more, risk scores or ranking queues for the client. Based on an assigned acuity level, the percolator system may determine a type of outreach, frequency, and type of staff. For example, and not limitation, members placed at the highest acuity level may be outreached by the most skilled and trained staff members, many times in a face to face encounter or multiple times in a short period of time. For further example, members placed at the lowest acuity level may be outreached by non-licensed staff, telephonically or through other methods of communication, and may receive less intensive outreach schedules.

In a ranking phase, the system may rank all members individually to assure that members deemed to have the most urgent or impactable needs are reached out to first. The percolator system may also provide rankings of issues for each member, to assure that issues are addressed in a prioritized manner. Accordingly, a resulting outreach workflow created by the percolator system may direct health coaches to assess and intervene based on each member's specific needs and, in some embodiments, may provide a specific sequencing of tasks for the member so as to address the member's most urgent needs first.

After data related to a client's members is received and initially processed, the percolator system may involve three basic steps: validation of a health condition, risk assignment (which may determine disease burden and complexity), and identification of actionable gaps in healthcare and contractually required interventions with the members.

The validation process may select members with certain health conditions. To verify the accuracy of condition identification, the percolator system may cross reference multiple data sources and, in some embodiments, repeatedly scan for updates in members' information. When determining disease burden, the percolator system may consider a variety of factors, such as disease complications, utilization patterns, demographics, co-morbidities, and other factors that may be likely to place a member at a higher risk for worsening his or her condition, developing a condition, or increasing utilization of the client's services. The percolator system may identify care gaps based on evidence of, for example, lack of essential support systems (e.g. shelter, transportation, and care coordination), lack of treatment adherence, or lack of prevention and screening tasks. The percolator system may also identify gaps based on specific contract requirements with the client. For example, and not limitation, if a contract requires that a specific health assessment is performed within a predefined timeframe, the percolator system may place this task as a gap, and this gap may be added to other care gaps that the member may have. From these determinations, the percolator system may produce priority rankings for outreach based on urgency, impactability, or client-specific preferences and requirements.

Referring now to the figures, in which like reference numerals represent like parts throughout the views, various embodiments of the percolator systems and methods will be described in detail.

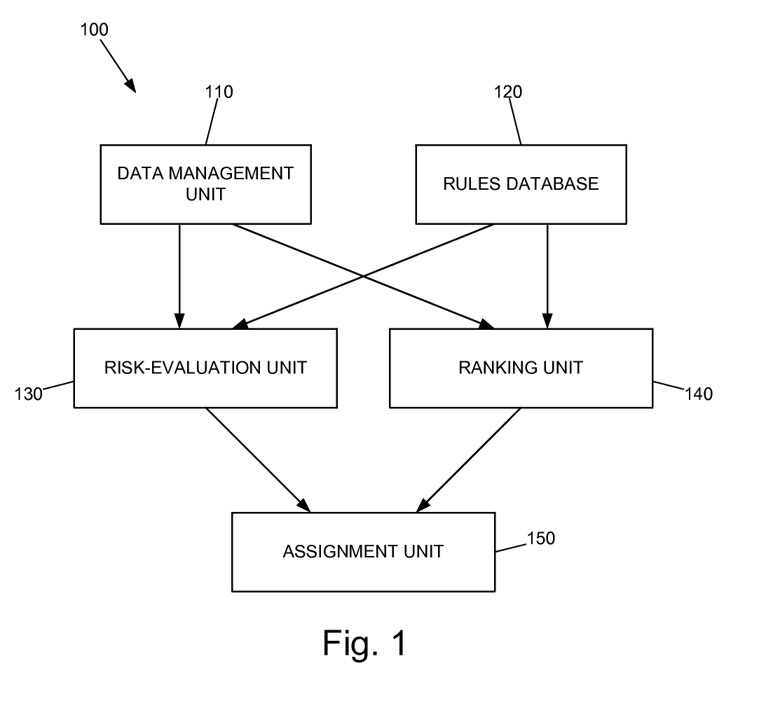

FIG. 1 illustrates a flow diagram of a percolator system 100, according to an exemplary embodiment. As shown, an exemplary system may include a data management unit 110, a rules database 120, a risk-evaluation unit 130, a ranking unit 140, and an assignment unit 150. As shown, the various units may be in communication with one another for operation of the percolator system 100.

Generally, the data management unit 110 may provide historical data related to the members, for analysis by the percolator system 100; the rules database 120 may maintain a plurality of rules for scoring the various members of the client with which the percolator system 100 is associated; the risk-evaluation unit 130 may assess risks associated with the members and categorize the members into risk groups; the ranking unit 140 may calculate an outreach score for each member based on application of the rules in the rules database 110; and the assignment unit 150 may create a workflow for outreach activities related to the members.

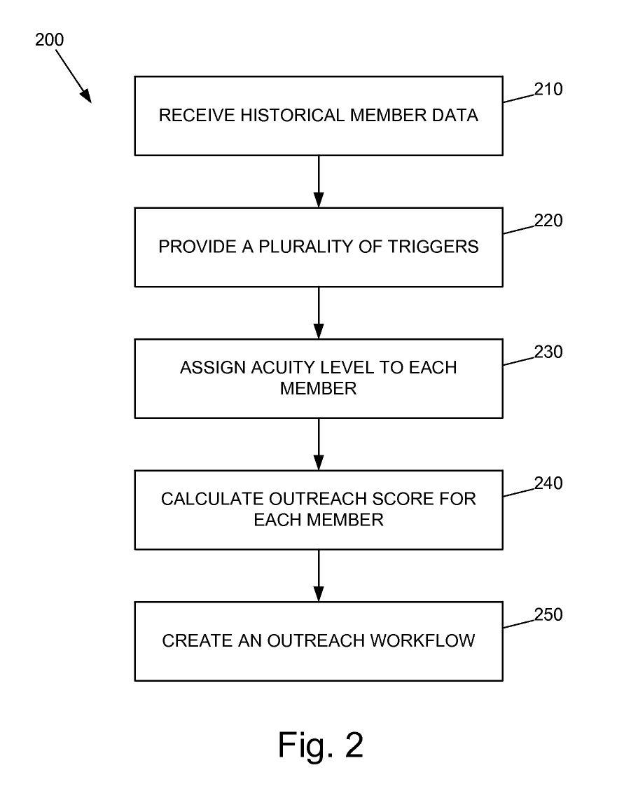

FIG. 2 illustrates a flow diagram of a percolator method 200, according to an exemplary embodiment. The percolator method 200 may provide the various operations performed by the analogous percolator system 100. As shown in FIG. 2, the method 200 may comprise: at 210, receiving historical data related to the members to be analyzed; at 220, providing a plurality of triggers for evaluating the members; at 230, assigning an acuity level or risk level to each member; at 240, calculating an outreach score for each member based, at least in part, on the triggers; and at 250, creating an outreach workflow based on the members' acuity levels and outreach scores.

Some embodiments of the percolator systems and methods are embodied, in whole or in part, in a non-transitory computer-readable medium executable by a computer processor. The units and method shown in FIGS. 1-2 are provided for illustrative purposes only, and it will be understood that the percolator systems and methods may include alternative or additional units or steps as well. It will be further understood that the various units may be implemented in various manners, and they may comprise hardware, software, or a combination thereof. Further, the distinctions between these units made throughout this disclosure are illustrative operative distinctions only, and thus, these various units may be implemented by shared hardware or software.

### The Data Management Unit

The data management unit 110 may provide data about members to the percolator system 100 for analysis. The data management unit 1110 may be implemented in various ways, depending on the resources available to the percolator system 100 and desired implementation details. For example and not limitation, the data management unit 110 may be a local or remote database, or it may be a system or processor configured to access remote data from one or more sources. The data management unit 110 may comprise hardware, software, or a combination thereof, and it may comprise various structures capable of performing functions of providing input data for the percolator system.

It may receive unprompted data updates from one or more external sources, or alternatively, it may monitor or query external sources for data updates. It also may monitor and query internal sources, such as information provided by members or captured by staff through interactions with members. In an exemplary embodiment, the data management unit 110 provides data related to member health or social history. For example, and not limitation, the data management unit may access prior healthcare insurance claims, pharmacy records, health reimbursement accounts, medical records, biometric measures, or other patient or system-provided data. This data may be analyzed by other aspects of the percolator systems to provide risk, rankings and workflow.

### The Rules Database

The rules database 120 may be local or remote storage for business rules, business rule sets, triggers, trigger weights, role assignments, or some or all of these. It will be understood that the term “database” refers to a set of data organized in some manner. As used throughout this disclosure, this term may refer to various arrangements of data, and such data need not be stored at a single location. The rules database 120 may comprise hardware, software, or a combination thereof, and it may comprise various structures capable of performing functions of storing or managing business rules, business rule sets, or triggers.

A trigger may be a combination of business rule sets, and a business rule set may be a combination of business rules. The trigger weights may determine the impact a corresponding trigger has on a member's rankings. A trigger weight may be constant, i.e., not changing over time, or it may increase or decrease over time based on the application of one or more business rules or other predetermined criteria. Weights may be calculated in relative terms based on characteristics of the client's members. This may allow for calibrating the impact of any given rule based on its prevalence in the clients population.

Triggers may be separated into groups of impactability, for example: very high, high, medium, and low. This unique structure may allow for triggers with higher importance to provide a ranking above that of triggers with lower importance, regardless of the number of triggers with lower importance that may exist for a given member. For example, a member with one very high trigger category may always rank above a member with multiple low trigger categories.

In an exemplary embodiment, the business rules, business rule sets, and triggers may be customized for the client to emphasize the client's outreach concerns. For example, the trigger weights, increase and decrease in weights, and role assignment for each rule may be customized for each client to support the specific needs and staffing model for that client.

A business rule may represent a single question, combination of questions, or a numeration used to evaluate a member. A business rule may be a parameter used to examine a member's healthcare background, present healthcare, prospective healthcare, or ability to obtain healthcare or comply with guidelines for maintaining or improving the member's health situation, or used to evaluate a contract requirement that the member might be missing. In an exemplary embodiment, a business rule may have a yes or no answer for each member, but alternatively, an answer to a business rule may be scored or otherwise quantified. For example, a business rule may represent the following question: “Has a plan of care been approved?” For each client, a finite set of business rules may be identified that are relevant to its needs. A business rule set may be a predetermined collection of business rules grouped together with conditional AND or OR conditions (i.e., using the Boolean AND or OR operator, respectively). Collection of business rules into business rule sets may serve various purposes. For example, a business rule set may enable convenient reuse of business rules that are grouped together to form parts of multiple triggers. In some instances, business rules may be used to assign staff in specific roles, so that appropriate members with selected issues are routed to the roles assigned to deal with selected members and issues.

Some business rules may be constructed to create a client-specific risk evaluation and ranking system. For example, a rule may identify the top 5% most complex insured for a given client. This may allow selection of the most appropriate insured for a given client based on the client's unique mix of patients and complexities, instead of using uniform rules across clients that may or may not apply to each individual client.

### The Risk-Evaluation Unit

The risk-evaluation unit 130 may assign an acuity level, or risk level, to members associated with the client. The data risk-evaluation unit 130 may comprise hardware, software, or a combination thereof, and it may comprise various structures capable of performing risk-assessment functions.

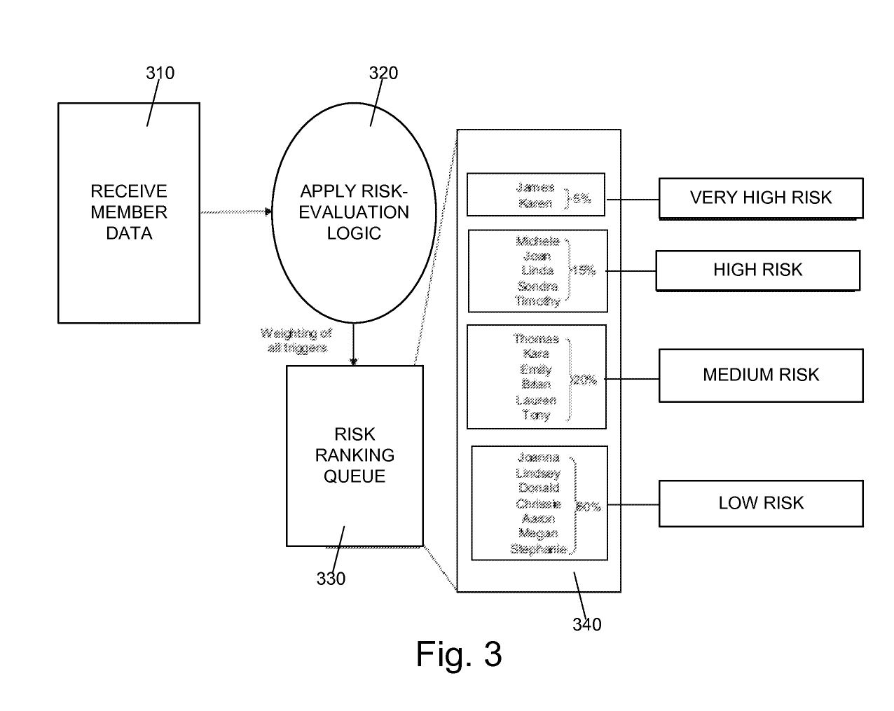

FIG. 3 illustrates a flow diagram of a method of the risk-evaluation unit 130, according to an exemplary embodiment of the percolator system. As shown in FIG. 3, after member data is received from the data management unit 110, at 310, logic is applied to identify risk-indicating issues in each member's history, as shown at 320. The applied logic may be one or more triggers in the rules database 120, where these triggers may be specifically selected to identify risk.

The triggers applied for risk assessment may be based on various factors, including, for example: chronic illness and disability payment system (“CDPS”), actual cost per member per month (“PMPM” cost), complexity (i.e., number of chronic conditions and providers), ambulatory care sensitive admissions, hospitalizations and readmissions, predictive models for emergency room visits and hospitalizations, and other factors implying uncoordinated care practices or otherwise indicating risk. The percolator system 100 may calculate a risk score for each member. If a trigger is deemed to be true for a particular client, then the weight associated with that trigger may be included to the member's risk score. Thus, a member's risk score may be the sum, or some other predetermined combination, of the weights of each risk-associated trigger determined to be true for that member.

One factor that may be considered for risk-scoring, CDPS, is a system that was developed by the University of California at San Diego specifically for use on Medicaid populations. CDPS is also a diagnosis-based risk measurement tool that produces thirty major categories of disease corresponding to body systems or type of diagnosis, further subdivided into subcategories by the degree of expenditures associated with the diagnosis, e.g., low, medium and high. CDPS depends on diagnosis codes from professional and hospital claims data. The most recent version of CDPS (5.1) also has the capacity to include pharmacy claims data. In addition to classifying individuals into one or more disease and severity classes, CDPS also produces concurrent and predictive risk scores intended to be estimates of relative risk within the population. While the CDPS system was originally developed to risk-adjust payments to capitated providers under the Medicaid program, its predictive value may also be useful for projection of future claims costs.

CDPS may be particularly useful as a factor for Medicaid contracts. For commercial contracts, an exemplary embodiment of the percolator system 100 may use an analogous concept factor, such as adjusted clinical groups (ACG) or hierarchical condition categories (HCC).

Another potential factor, PMPM cost, may be incorporated into the risk score based on its own ranking of the members. The percolator system may identify the total medical claims and prescription drug claims costs during a predetermined period for each member, such as the most recent twelve months of available claims. The average total of these for a member may be deemed to be the total monthly paid amount for a member. The percolator system may rank the members based on the PMPM and compute each individual member's PMPM percentile. That percentile may be integrated into the member's risk score.

A complexity factor may be included each member's risk score. In some embodiments, a first algorithm may calculate, for each member, a total number of chronic conditions as determined from the data provided by the data management unit 110. A second algorithm may sum the total number of providers each member utilizes. A third algorithm may sum the total number of medications prescribed to each member in a given period. The percolator system 100 may combine two or three of these totals, possibly along with other considerations, into a complexity factor to be included in the member's risk score.

The percolator system 100 may then rank the members, as shown at 330 of FIG. 3, according to their risk scores. Based on the members' risk-score rankings, the percolator system 100 may assign an acuity level to each member, as shown at 340. A member's acuity level may eventually determine the type and intensity of outreach efforts for the corresponding member.

In an exemplary embodiment, the acuity levels are assigned based on rankings of risk scores, so that members with similar scores may be assigned similar acuity levels. For example, and not limitation, the acuity levels may be based on the percentiles within the risk score rankings. It need not be the case that each acuity level includes the same number of members; this may be determined based on the business goals of the client. The fraction of members at each acuity level may vary from client to client, based on the client's staffing levels, product and contract requirements, or on other relevant considerations

Periodically, the percolator system 100 may recalculate the members' acuity levels by reapplying the risk scoring algorithms. For example, this may be performed once per month or on a weekly basis. If a member's acuity level has changed, a staff member may be alerted and instructed to re-assess the member and confirm the new acuity. In some embodiments, staff may have the ability to override an assigned acuity level based on clinical expertise, but this ability may be restricted based on the extremity of the requested override.

The percolator system 100 may use acuity levels to ensure minimum contact levels are maintained. In some embodiments, members assigned with high and moderate acuities are contacted at least every sixty days or according to some other, predetermined schedule.

### The Ranking Unit

After acuity levels are assigned, the percolator system 100 may then identify and prioritize members for outreach. In some embodiments, the ranking unit 140 may perform the prioritization. The ranking unit 140 may comprise hardware, software, or a combination thereof, and it may comprise various structures capable of performing functions of prioritizing members.

To this end, the ranking unit 140 may calculate an outreach score for each member. An outreach score may be based on one or more factors or triggers, including, for example and not limitation, assigned acuity level (as discussed above), treatment gap analysis, uncoordinated care behavior indicators, polypharmacy, multiple providers or lack of a primary care provider, admissions and re-admissions, follow-up treatments after hospitalization, national standards of care gaps (HEDIS, STAR, NQF), and workflow considerations.

Triggers related to workflow considerations may be designed to ensure that appropriate tasks are assigned to appropriately skilled people for outreach and that contractual and regulatory requirements are met. Triggers may be designed to facilitate contacting members within required timeframes and in specific sequences of interventions, based in part on client preferences and regulatory requirements. For example, and not limitation, triggers may help ensure that clinical tasks are assigned to clinical personnel; that non-clinical tasks are assigned to non-clinical personnel; and that intervention tasks are appropriately sequenced and timed to meet contractual and regulatory requirements.

In an exemplary embodiment of the percolator system 100, an outreach score for a member may be calculated as a combination of weights, where each weight is associated with a predetermined trigger. If a trigger holds true for a member, then the weight associated with that trigger may be included in the member's outreach score. The value of a trigger's weight may indicate the importance or priority of the trigger. Thus, for example, a trigger representing a high risk factor may have a high associated weight, and a trigger for a low risk factor may have a relatively lower weight. An insurer or other client or user of the percolator system 100 may select the weights for the each trigger based on the specific needs and goals of the insurer. A member's outreach score may be calculated by combining all of the weights for the applicable triggers.

To allow for a more precise scoring, a trigger may be categorized in one or more of the following respects:
Grouping: Each trigger may be assigned a level of importance, such as very high, high, medium, or low. The percolator system may be designed to assure that higher-level triggers come before lower-level triggers in the outreach scoring, regardless of the number of triggers in each group. Accordingly, a member to which a higher-level trigger applies may always be prioritized above a member to whom a lower-level trigger applies. This result may be achieved by enabling a high-level trigger to impact an outreach score to such a degree more than the lower-level trigger that no combination of lower-level trigger can match that impact.
Relative weight: Each trigger may be assigned a relative weight within its assigned group, in order to refine the outreach efforts in large populations and assure appropriate prioritization.
Sliding scale: A trigger may change its weight dynamically based on number of occurrences of that trigger or the timeliness of the trigger.
   The “timeliness” of a trigger may refer to two functions: deadline and the time to most recent event. Regarding deadlines: For example, as a deadline approaches, the weight of the associated trigger can increase according to a predetermined sliding scale. Regarding time to most recent event: For example, the closer in time a past acute event is to an intervention, the higher the weight of the associated trigger, because the impact of that event on the member may be higher than if the event had occurred further in the past.
   The “number of occurrences” counts, for example, how many times an “unfavorable event” has occurred, such as hospitalization, and assigns higher weight relative to the count.

Some embodiments of the percolator system 100 may include not only triggers that are directly relevant to healthcare, but also triggers that may be relevant to the support structure that a member has for obtaining healthcare. For example, a trigger may be related to social characteristics of members. For example, and not limitation, a trigger may represent whether a member has transportation to healthcare appointments, whether the member has family members, whether family members accompany the member to healthcare appointments, whether the member has a telephone, or other social factors that may be relevant to the member's ability or willingness to take advantage of healthcare services. In some embodiments, one or more triggers may be related to a member's economic situation. For example, and not limitation, a trigger may represent a member's income or employment status.

The percolator system 100 may rank members according to their outreach scores, and may assign one or more members to outreach professionals based on their rankings. A subset of the members corresponding to the highest outreach scores may be included in outreach efforts.

### The Assignment Unit

Using the outreach scores and acuity levels, the percolator system 100 may output a workflow, preferably on a daily basis, instructing outreach staff as to which members should be reached and for what purpose. If a member is assigned a high acuity level, but no actionable and impactable interventions are identified, the member may remain invisible in the outreach queue until an opportunity for an intervention arises. This may allow for targeting only those members who would likely benefit from an intervention.

The assignment unit 150 may provide a workflow for outreach for one or more members of the client who are deemed to qualify for outreach. The assignment unit 150 may comprise hardware, software, or a combination thereof, and it may comprise various structures capable of performing functions of providing a workflow or otherwise providing outreach instructions or direction.

As discussed above, a member's outreach score may be used to determine whether a member qualifies for outreach. If an outreach score meets a set of predetermined criteria, the associated member may be flagged for outreach and may be added to the workflow. Based on an assigned acuity level of a member flagged for outreach, the percolator system 100 may select a required skill level of a health professional to service the member, a type of outreach services to be received by the member (e.g., telephone call, field visit), a frequency at which the member is to receive these services, or a combination of these and other workflow aspects.

In some embodiments, the assignment unit 150 may access a set of assignment triggers, which the percolator system 100 may evaluate to determine aspects of the workflow. For example, applicability of a trigger related to lack of physical mobility may require that the member receive a field visit, as it may be the case that such a member does not visit medical facilities as regularly as needed.

The assignment unit 150 may also evaluate triggers or other factors to rank and thus prioritize each member's medical issues. As a result, the assignment unit 150 may inform outreach professionals of which issues should receive focus during an outreach session. In some embodiments, the assignment unit may also provide a list of questions or tasks for an outreach professional to ask or perform for a member during the outreach.

### Exemplary Computer System

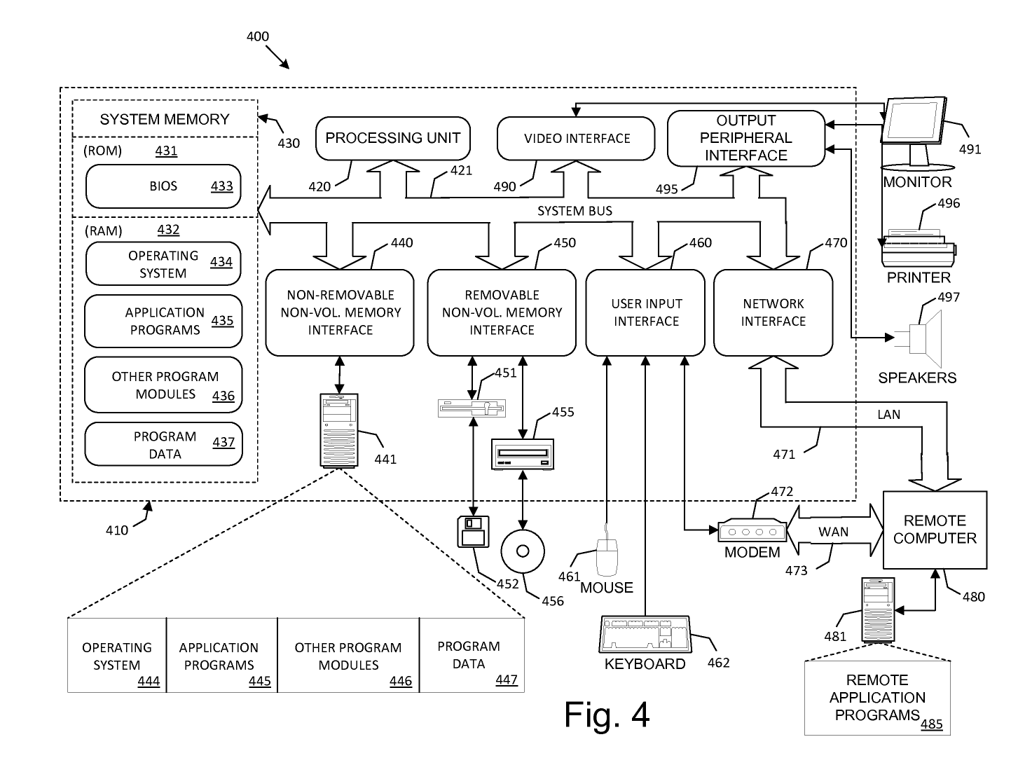

FIG. 4 illustrates an architecture of an exemplary computing device used for implementation of the percolator system, according to an exemplary embodiment of the present invention. As mentioned above, one or more aspects of the percolator system 100 and related methods 150 can be embodied, in whole or in part, in a computing device 400. FIG. 4 illustrates an example of a suitable computing device 400 that can be used.

Although specific components of a computing device 400 are illustrated in FIG. 4, the depiction of these components in lieu of others does not limit the scope of the invention. Rather, various types of computing devices 400 can be used to implement embodiments of the percolator system 100. Exemplary embodiments of the percolator system 100 can be operational with numerous other general purpose or special purpose computing system environments or configurations.

Exemplary embodiments of the percolator system 100 can be described in a general context of computer-executable instructions, such as one or more applications or program modules, stored on a computer-readable medium and executed by a computer processing unit. Generally, program modules can include routines, programs, objects, components, or data structures that perform particular tasks or implement particular abstract data types.

With reference to FIG. 4, components of the computing device 400 can comprise, without limitation, a processing unit 420 and a system memory 430. A system bus 421 can couple various system components including the system memory 430 to the processing unit 420.

The computing device 400 can include a variety of computer readable media. Computer-readable media can be any available media that can be accessed by the computing device 400, including both volatile and nonvolatile, removable and non-removable media. For example, and not limitation, computer-readable media can comprise computer storage media and communication media. Computer storage media can include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store data accessible by the computing device 400. For example, and not limitation, communication media can include wired media such as a wired network or direct-wired connection, and wireless media such as acoustic, RF, infrared and other wireless media. Combinations of any of the above can also be included within the scope of computer readable media.

The system memory 430 can comprise computer storage media in the form of volatile or nonvolatile memory such as read only memory (ROM) 431 and random access memory (RAM) 432. A basic input/output system 433 (BIOS), containing the basic routines that help to transfer information between elements within the computing device 400, such as during start-up, can typically be stored in the ROM 431. The RAM 432 typically contains data and/or program modules that are immediately accessible to and/or presently in operation by the processing unit 420. For example, and not limitation, FIG. 4 illustrates operating system 434, application programs 435, other program modules 436, and program data 437.

The computing device 400 can also include other removable or non-removable, volatile or nonvolatile computer storage media. By way of example only, FIG. 4 illustrates a hard disk drive 441 that can read from or write to non-removable, nonvolatile magnetic media, a magnetic disk drive 451 for reading or writing to a nonvolatile magnetic disk 452, and an optical disk drive 455 for reading or writing to a nonvolatile optical disk 456, such as a CD ROM or other optical media. Other computer storage media that can be used in the exemplary operating environment can include magnetic tape cassettes, flash memory cards, digital versatile disks, digital video tape, solid state RAM, solid state ROM, and the like. The hard disk drive 441 can be connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4 can provide storage of computer readable instructions, data structures, program modules and other data for the computing device 400. For example, hard disk drive 441 is illustrated as storing an operating system 444, application programs 445, other program modules 446, and program data 447. These components can either be the same as or different from operating system 434, application programs 435, other program modules 436, and program data 437.

A web browser application program 435, or web client, can be stored on the hard disk drive 441 or other storage media. The web client 435 can request and render web pages, such as those written in Hypertext Markup Language, in another markup language, or in a scripting language.

A user of the computing device 400 can enter commands and information into the computing device 400 through input devices such as a keyboard 462 and pointing device 461, commonly referred to as a mouse, trackball, or touch pad. Other input devices (not shown) can include a microphone, joystick, game pad, satellite dish, scanner, electronic white board, or the like. These and other input devices are often connected to the processing unit 420 through a user input interface 460 coupled to the system bus 421, but can be connected by other interface and bus structures, such as a parallel port, game port, or a universal serial bus. A monitor 491 or other type of display device can also be connected to the system bus 421 via an interface, such as a video interface 490. In addition to the monitor, the computing device 400 can also include other peripheral output devices such as speakers 497 and a printer 496. These can be connected through an output peripheral interface 495.

The computing device 400 can operate in a networked environment, being in communication with one or more remote computers 480 over a network. The remote computer 480 can be a personal computer, a server, a router, a network PC, a peer device, or other common network node, and can include many or all of the elements described above relative to the computing device 400, including a memory storage device 481.

When used in a LAN networking environment, the computing device 400 can be connected to the LAN 471 through a network interface or adapter 470. When used in a WAN networking environment, the computing device 400 can include a modem 472 or other means for establishing communications over the WAN 473, such as the internet. The modem 472, which can be internal or external, can be connected to the system bus 421 via the user input interface 460 or other appropriate mechanism. In a networked environment, program modules depicted relative to the computing device 400 can be stored in the remote memory storage device. For example, and not limitation, FIG. 4 illustrates remote application programs 485 as residing on memory storage device 481. It will be appreciated that the network connections shown are exemplary and other means of establishing a communications link between computers can be used.

While the percolator systems and methods have been disclosed in exemplary forms, it will be apparent to those skilled in the art that many modifications, additions, and deletions may be made without departing from the spirit and scope of these methods, systems, and their equivalents, as set forth in the following claims.

What is claimed is:

1. A computer-implemented method comprising:
receiving a plurality of data related to healthcare of a plurality of members;
assigning automatically an acuity level to each of the plurality of members by applying a risk-determination algorithm to the received data, the risk-determination algorithm being based on a predetermined set of risk factors;
applying, with a computer processor, a prioritization algorithm to the received data, the prioritization algorithm being based on a set of predefined triggers;
prioritizing the plurality of members for outreach based on the results of the prioritization algorithm; and
providing an outreach plan for a first member based at least partially on the acuity level assigned to the first member.

2. The method of claim 1, wherein at least one of the predefined triggers is related to a social characteristic of the plurality of members.

3. The method of claim 1, wherein at least one of the predefined triggers is based on whether a member has transportation to healthcare appointments, whether family members of the member accompany the member to healthcare appointments, or whether the member has a telephone.

4. The method of claim 1, each predefined trigger being associated with a predetermined weight.

5. The method of claim 4, wherein applying a prioritization algorithm to the received data comprises scoring each of the plurality of members.

6. The method of claim 5, wherein scoring the plurality of members comprises including in a first score of the first member the associated weight of each of the predefined triggers that are deemed applicable to the first member.

7. The method of claim 5, wherein providing an outreach plan for a first member comprises selecting an outreach professional to contact the first member, wherein the selection of the outreach professional is based at least partially on the first member's acuity level or score.

8. A computer program product embodied in a non-transitory computer-readable medium, the computer program product comprising an algorithm adapted to effectuate a method, the method comprising:
receiving a plurality of data related to healthcare of a plurality of members;
applying a risk-determination algorithm to the received data, the risk-determination algorithm being based on a predetermined set of risk factors;
assigning an acuity level to each member based on results of the risk-determination algorithm;
providing a plurality of triggers, each trigger being related to a healthcare issue and being associated with a predetermined weight;
calculating an outreach score for each of the plurality of members based on applicability of each of the plurality of triggers; and
providing an outreach plan for the plurality of members based on the acuity levels and outreach scores.

9. The computer program product of claim 8, the risk-determination algorithm being configured to rank the plurality of members, and to assign acuity levels based on the rankings.

10. The computer program product of claim 8, wherein at least one of the triggers is related to a social characteristic of the plurality of members.

11. The computer program product of claim 9, wherein at least one of the triggers is based on whether a member has transportation to healthcare appointments, whether family members of the member accompany the member to healthcare appointments, or whether the member has a telephone.

12. The computer program product of claim 8, wherein providing an outreach plan comprises flagging a subset of the plurality of members for outreach and prioritizing the issues related to each flagged member.

13. A system comprising:
a rules database configured to maintain a plurality of business rules used to evaluate member data associated with a plurality of members;
a risk-evaluation unit configured to assign each of the plurality of members to an acuity level based on application of one or more of the business rules that are deemed related to risk-assessment;
a ranking unit configured to calculate a score for each of the plurality of members based on one or more of the business rules; and
an assignment unit configured to provide an outreach workflow based on the acuity levels and scores of the members, wherein the scores determine which members are flagged for outreach and the acuity levels determine one or more characteristics of each outreach.

14. The system of claim 13, further comprising a plurality of predefined triggers, each trigger being a combination of one or more business rules, together being applicable to the acuity levels or the scores.

15. The system of claim 14, the rules database associating each trigger with a predetermined weight, and the scoring unit configured to calculate a score for a first member by combining the weights of one or more triggers applicable to the first member.

16. The system of claim 15, the assignment unit configured to assign outreach only for a subset of the plurality of members whose scores meet a predetermined set of criteria.

17. The system of claim 13, the assignment unit being further configured to prioritize member-specific issues for one or more of the members flagged for outreach.

18. The system of claim 13, the assignment unit being further configured to prioritize a plurality of member-specific workflow issues for one or more of the members flagged for outreach.

19. The system of claim 13, further comprising a data management unit configured to gather the member data from one or more external and internal sources.

20. The system of claim 19, the data management unit accessing healthcare claims, pharmaceutical records, medical records, health reimbursement account records, or appointment histories.
